(19) United States
(12) Patent Application Publication
(10) Pub. No.: US 2011/0114741 A1
(43) Pub. Date: May 19, 2011

(54) MOBILE HEATING DEVICE

(75) Inventor: Roland Kaindl, Durneck (DE)

(73) Assignee: WEBASTO AG, Stockdorf/Gauting (DE)

(21) Appl. No.: 12/995,360

(22) PCT Filed: Aug. 26, 2008
(86) PCT No.: PCT/EP2008/061169

§ 371 Date: Dec. 16, 2010

(30) Foreign Application Priority Data
Jul. 22, 2008 (DE) 20 2008 000 097.1

(51) Int. Cl. B60H 1/22; F01N 13/08

(52) U.S. Cl. 237/28; 181/228

(57) ABSTRACT

A mobile heating device, in particular a vehicle heating device, is provided. The mobile heating device comprises: a burner in which fuel and combustion air are convertible producing heat; a combustion air supply for supplying the combustion air to the burner; and an exhaust gas outlet for discharging combustion exhaust gases from the burner. A hydrocarbon storing element is arranged in the combustion air supply and/or in the exhaust gas outlet. Further, a combustion air supply sound absorber for a mobile heating device and an exhaust gas outlet sound absorber for a mobile heating device are provided.

The present invention relates to a mobile heating device, in particular to a vehicle heating device, which comprises a burner in which fuel and combustion air are convertible producing heat, a combustion air supply for supplying combustion air to the burner, and an exhaust gas outlet for discharging combustion exhaust gases from the burner. Further, the invention relates to a combustion air supply sound absorber and to an exhaust gas outlet sound absorber for a mobile heating device.

Heating devices of this kind are, below others, employed in vehicles, in particular in engine-driven land vehicles, as parking heaters or auxiliary heaters for heating a vehicle interior and/or coolant of the vehicle. Parking heaters are operable both when the vehicle combustion engine is running and when it is at rest, while auxiliary heaters or only operable when the vehicle combustion engine is running. In such heating devices, fuel and combustion air are converted in a flaming combustion in a burner such that heat is produced, which heat is used for heating. The hot exhaust gases resulting from the combustion process are usually routed via one (or several) heat exchanger(s) in which heat is transferred to a second medium (or even a plurality of second media, as the case may be). Depending on the construction of the heat exchanger, the second medium can be gaseous, such as e.g. air (in an air-to-air heat exchanger), or liquid, such as e.g. coolant (in an air-to-coolant heat exchanger).

In heating devices of this kind, a combustion air supply is provided via which the combustion air is supplied to the burner. Further, an exhaust gas outlet discharging the combustion exhaust gases from the burner is provided. During operation of the heating device, i.e. during operation of the burner contained therein, on the one hand, the combustion air flows through the combustion air supply into the heating device with relatively high velocity and, on the other hand, the combustion exhaust gases also flow through the exhaust gas outlet out of the heating device with relatively high velocity. These flows generate noise. Further deflection of combustion air in the burner and the actual combustion process in the burner also cause noise. This noise is perceived as being unpleasant or annoying by users of mobile heating devices.

It is known to provide sound absorbers adapted to absorb the above described noise at the combustion air supply and/or at the exhaust gas outlet in mobile heating devices. Usually, these sound absorbers are provided outside of the actual heating device in a combustion air supply pipe and/or in an exhaust gas outlet pipe. Sound absorbers of this kind can be formed as absorption-type sound absorbers absorbing the noise or as reflection-type sound absorbers multiply reflecting and refracting the noise. Realization as an absorption-type sound absorber enables space-saving accommodation of the sound absorber.

Further, mobile heating devices are usually adapted not to be operated in continuous operation but only when there is a demand for (additional) heating power. Due to this, the heating devices are in an inoperative state for relatively long periods, i.e. in a state in which the burner is inoperative. Also in this state, due to their way of construction, the combustion air supply and the exhaust gas outlet are open with respect to an exterior of the heating device, which in applications in a vehicle is usually with respect to an exterior of the vehicle. Upon shutting down the burner, typically residual fuel is still present in the fuel supply and in an inlet region of the burner. Further, unconsumed fuel constituents can still be present in the region of the burner. In typical mobile heating devices, usually hydrocarbon compositions such as benzine, diesel or gas are used as fuel. Thus, the remaining residual fuel and the fuel constituents typically are hydrocarbons. When the burner is inoperative, these unburned hydrocarbons may evaporate in the heating device and pass to the exterior of the heating device via the combustion air supply and the exhaust gas outlet (potentially via sound absorbers which may be provided). This problem particularly occurs with mobile heating devices operated with benzine as a fuel, but also with those operated with e.g. gas or diesel.

Thus, in known mobile heating devices undesired emissions of unburned hydrocarbons to the environment occur. Admissibility of such emissions is restricted by law and reduction of such emissions is a general aim.

It is an object of the present invention to reduce the emission of unburned hydrocarbons in mobile heating devices.

This object is solved by a mobile heating device, in particular a vehicle heating device, according to claim 1. The mobile heating device comprises: a burner in which fuel and combustion air are convertible producing heat; a combustion air supply for supplying the combustion air to the burner; and an exhaust gas outlet for discharging combustion exhaust gases from the burner. A hydrocarbon storing element is arranged in the combustion air supply and/or in the exhaust gas outlet. Thus, in the mobile heating device at least one hydrocarbon storing element is arranged either in the combustion air supply or in the exhaust outlet or in both. Hydrocarbon storing elements means structures on or in which the evaporating unburned hydrocarbons, in particular benzine vapor, can be adsorbed or absorbed. By provision of the hydrocarbon storing elements, emissions of unburned hydrocarbons to the environment are reliably reduced.

In the present context, “mobile heating device” means a heating device which is constructed for use in mobile applications and is suitably adapted. In particular, this means that it is transportable (for instance mounted to a vehicle or just accommodated therein for transport) and not solely adapted for permanent stationary use as it is the case with regard to e.g. permanent installation of a building heating device in a building. The mobile heating device is particularly adapted for heating a vehicle interior, such as e.g. of a land vehicle, a water vehicle, or air craft, as well as a partly-open space such as can e.g. be found on boats, in particular on yachts. Further, the mobile heating device may also temporarily be used in a stationary manner, such as e.g. in large tents, containers such as containers for construction and the like. Preferably, the mobile heating device is formed as a parking heater for motor vehicles, particularly for engine-driven land vehicles. Thus, in particular fixedly mounted heating systems in mobile installation objects such as vehicles are also mobile heating devices.

Preferably, liquid fuel is used in the mobile heating device. The liquid fuel can e.g. be taken from a fuel tank of the motor vehicle.

“Burner” is generally used to mean a device in which fuel (gaseous or liquid) and combustion air are converted in a flaming combustion such that heat is released. For example, an evaporation burner or a burner comprising an atomizing nozzle can be used as a burner. In an evaporation burner (liquid) fuel is evaporated on a (typically porous) surface and converted with supplied combustion air in a flaming combustion. In a burner having an atomizing nozzle, (liquid) fuel is evaporated by the supplied combustion air in the atomizing nozzle and is converted with the combustion air in a flaming combustion.

Preferably, the hydrocarbon storing element comprises a structure capable of being flown through having a large surface in relation to its volume. In this case, it is reliably ensured that the hydrocarbon storing element comes into contact with the evaporating unburned hydrocarbons. Formation of a large surface in relation to the volume allows space-saving, efficient storing of hydrocarbon emissions. A remarkable amount of such emissions can be stored in small space. Realization can e.g. be accomplished by open-pored porous structures, such as e.g. sponge-like or foam-like structures, fabric structures, three-dimensional grid structures, and the like. A further advantage in this case is that the hydrocarbon storing element can simultaneously serve as a sound absorbing element of a sound absorber, such as e.g. of a combustion air sound absorber or exhaust gas sound absorber. Thus, sound absorption and emission reduction can be integrated in one component.

Preferably, the hydrocarbon storing element is adapted for storing hydrocarbons by adsorption. With such a realization, removal of the stored hydrocarbons is enabled in a simple manner, e.g. in the course of maintenance or by a certain control of the burner during its operation. However, storing of hydrocarbons by absorption is also possible. Materials are available which store hydrocarbons in a reliable manner via adsorption. Possible are in particular open-pored porous carrier structures (e.g. sponges, three-dimensional grids, etc.) which are provided with a hydrocarbon adsorbing coating. In the region of the combustion air supply, in particular cost-efficient plastic foams comprising e.g. an activated-coal coating as a hydrocarbon storing coating are possible. In the region of the exhaust gas outlet, in particular materials comprising higher heat resistance such as metal foams having a noble metal coating are possible. For example, a hydrocarbon storing material is known which is a single zeolite material allowing the storage effect for unburned hydrocarbons (in particular benzine vapors) and on which noble metals can deposit.

According to an advantageous realization, the hydrocarbon storing element is arranged such that, in operation of the heating device, it is passed through by the combustion air or the exhaust gases. In this case, the hydrocarbon storing element is located in the flow path and it is ensured that it reliably stores the hydrocarbon emissions even when the burner is in a turned off state. Further, in this case the hydrocarbon storing element can simultaneously serve as a sound absorber for noise absorption if it is geometrically realized such that it e.g. also absorbs sound. Furthermore, with such an arrangement the hydrocarbon storing element can also be “emptied” again during operation of the burner by, e.g. in an arrangement in a combustion air supply, transporting the stored hydrocarbons in the direction towards the burner with the combustion air and burning them there. In an arrangement in the exhaust gas section, e.g. conversion of the stored hydrocarbons with combustion exhaust gases can be effected during operation of the burner, possibly by an additionally provided catalytic effect of the hydrocarbon storing element.

Preferably, in both the combustion air supply and in the exhaust gas outlet at least one hydrocarbon storing element is arranged each. In this case, both emissions via the combustion air supply and those via the exhaust gas outlet can be reduced. Thus, a mobile heating device having very low overall emissions is provided.

According to a particularly advantageous further development, the hydrocarbon storing element is the sound absorbing element in a sound absorber. In this case, no extra space is needed for the storage function and the element takes over a double functionality. However, it is also possible for the hydrocarbon storing element to be only arranged in the sound absorber and to e.g. only partly replace a sound absorbing material which is additionally also present there. In this variant, different spatial arrangements of the respective materials are possible, e.g. consecutively in a flow direction, side by side, alternately arranged, etc.

According to an advantageous realization, the hydrocarbon storing element is arranged in a combustion air supply sound absorber absorbing noise arising from combustion air being supplied to the heating device. In this case, emission of unburned hydrocarbons via the combustion air supply in an inoperative state of the burner is reduced without requiring additional installation space.

According to a further advantageous realization, the hydrocarbon storing element is arranged in an exhaust gas outlet sound absorber absorbing noise arising from combustion exhaust gases being discharged. In this case, emission of unburned hydrocarbons via the exhaust gas outlet in an inoperative state of the burner is reduced without requiring additional installation space.

Preferably, the hydrocarbon storing element comprises a fully or partly porous structure, in particular a foam structure, a honeycomb structure, or a fiber structure. In this context, “porous structure” means a structure which is provided with a multiplicity of voids. In particular, a foam structure (e.g. metal foam, synthetic foam, etc.), a honeycomb structure (e.g. comprising square-shaped or honeycomb-shaped voids), a fabric or fibre structure (e.g. wool, resin soaked fleece fibers, thin metal wires, etc.) can be used as a carrier structure (with a corresponding hydrocarbon storing coating).

According to an advantageous realization, the hydrocarbon storing element is formed by a carrier structure having a hydrocarbon adsorbing coating. Again, in a corresponding manner it is preferably provided for the carrier structure to comprise a large surface in relation to its volume and to be formed as a structure capable of being flown through. For example, a metal foil formed in a honeycomb-shaped or square-shaped structure, a metal foam, monolithic ceramic, etc. can be used as a carrier structure. In particular activated-coal coatings (on the combustion air supply side) and certain noble metal coatings (on the exhaust gas outlet side) are possible as a hydrocarbon adsorbing coating. Realization with a carrier structure and a coating allows in particular cost-efficient production and optimization of the geometric structures.

If the hydrocarbon adsorbing coating is a noble metal coating, in particular use in the exhaust gas section in which higher temperatures occur is conveniently possible. If the hydrocarbon adsorbing coating is an activated coal coating, the advantages can be realized in a particularly cost-efficient manner, in particular in the region of the combustion air supply.

The object is also solved by a combustion air supply sound absorber according to claim 13. It is such a sound absorber for a mobile heating device which comprises: a burner in which fuel and combustion air are convertible producing heat; a combustion air supply for supplying combustion air to the burner; and an exhaust gas outlet for discharging combustion exhaust gases from the burner. A hydrocarbon storing element is arranged in a flow path of the combustion air supply sound absorber. The combustion air supply sound absorber also achieves the advantages already described above. In particular, with such a sound absorber already existing mobile heating devices can be retrofitted in a simple manner such that both annoying noise is attenuated and hydrocarbon emissions are reduced.

The object is also solved by an exhaust gas outlet sound absorber according to claim 14. It is such a sound absorber for a mobile heating device which comprises: a burner in which fuel and combustion air are convertible producing heat; a combustion air supply for supplying combustion air to the burner; and an exhaust gas outlet for discharging combustion exhaust gases from the burner. A hydrocarbon storing element is arranged in a flow path of the exhaust gas outlet sound absorber. The exhaust gas outlet sound absorber also achieves the advantages already described above. In particular, with such a sound absorber already existing mobile heating devices can be retrofitted in a simple manner such that both annoying noise is attenuated and hydrocarbon emissions are reduced.

Further advantages and features of the invention will become apparent from the following description of embodiments with referenced to the accompanying figures.

In the figures:

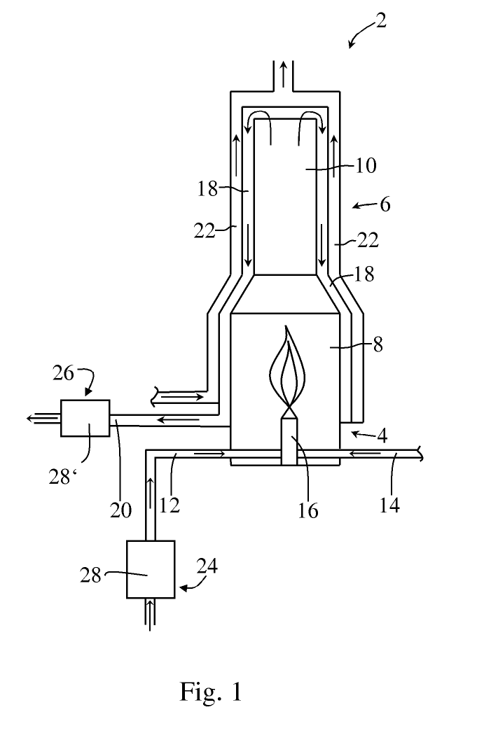

FIG. 1 shows a schematic illustration of a mobile heating device according to one embodiment of the present invention.

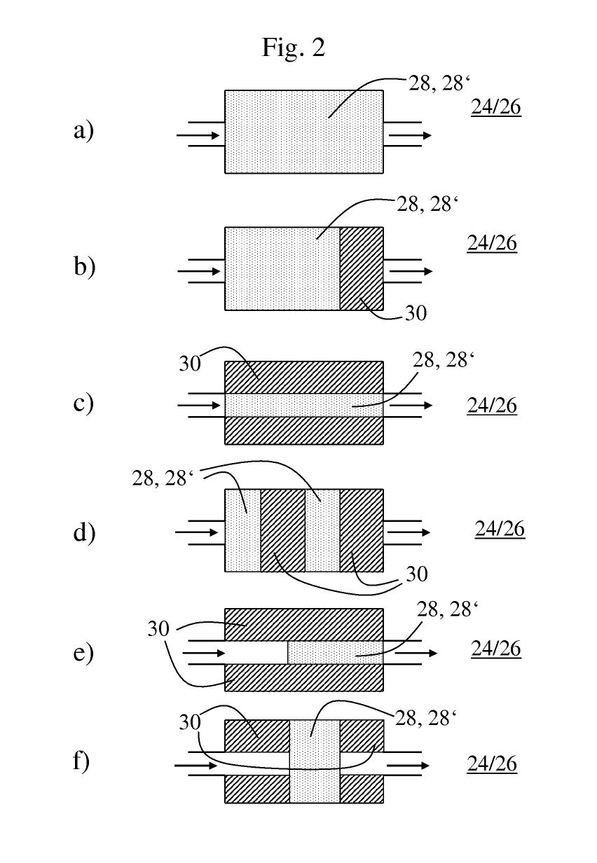

FIG. 2 a) to e) schematically show different possibilities of realization of a combustion air supply sound absorber or exhaust gas outlet sound absorber.

In the following, an embodiment will be described with reference to FIG. 1. In the embodiment, the mobile heating device is formed by a parking heater. In FIG. 1, a mobile fuel-operated heating device 2 forming a parking heater for an engine-driven land vehicle is depicted. In the schematic illustration, some components which are not relevant for the functioning according to the present invention are omitted and will not be explained. The heating device 2 comprises a burner 4 and a heat exchanger 6. The burner 4 comprises a combustion chamber 8, a flame tube 10 being arranged downstream of the combustion chamber 8 with regard to a flow direction of the gases, and an atomizing nozzle 12.

During operation, fuel (here: liquid fuel of the motor vehicle) and combustion air are converted in the burner 4 in a flaming combustion such that heat is produced. The combustion air is supplied to the burner 4 under pressure via a combustion air supply 14. To this end, e.g. a not shown combustion air blower is arranged in the heating device 2. The fuel is supplied to the burner 4 via a fuel supply 16. In the atomizing nozzle 12, the supplied combustion air effects atomization of the fuel and mixing of the combustion air and the fuel droplets. In the combustion chamber 8, the fuel is converted with the combustion air in a flaming combustion releasing heat. The gases resulting from the combustion (exhaust gases) flow into the heat exchanger 6 via the flame tube 10.

A first flow path 18 for the exhaust gases is formed in the heat exchanger 6. In the interior of the heat exchanger 6, the exhaust gases flow along the first flow path 18 to an exhaust gas outlet 20 via which the exhaust gases are discharged to the exterior. Further, a second flow path 22 in which coolant of the motor vehicle is guided is provided in the interior of the heat exchanger 6. The first 18 and second 22 flow paths are arranged such that heat is efficiently transferred from the exhaust gases to the coolant during operation. In the present embodiment, the flow direction of the exhaust gases and the flow direction of the coolant in the heat exchanger 6 are directed in opposite directions, as schematically depicted by the arrows in FIG. 1. The heated coolant is guided via a second heat exchanger (coolant-to-air heat exchanger) for heating air which is supplied to the vehicle interior. Further, the engine of the motor vehicle is pre-heated via the coolant.

As schematically depicted in FIG. 1, a combustion air supply sound absorber 24 is arranged in the combustion air supply 12. The combustion air supply sound absorber 24 attenuates noise resulting from the combustion process and from the supply of combustion air. As a variant which is not shown, it is possible that the combustion air supply sound absorber 24 on its input side comprises a water separator or humidity separator which prevents too much humidity from entering the burner 4 with the combustion air. Further, the combustion air supply sound absorber 24 can be formed such that it also effects filtering of the combustion air during operation of the burner 4.

As is also schematically depicted in FIG. 1, an exhaust gas outlet sound absorber 26 is provided in the exhaust gas outlet 20. The exhaust gas outlet sound absorber 26 attenuates noise on the side of the exhaust gas section resulting from the combustion process and from the combustion exhaust gases flowing out.

The respective sound absorber 24 and 26 are formed by components comprising an enlarged inner cross-section as compared to other portions of the combustion air supply 12 or other portions of the exhaust gas outlet 20. In the embodiment, the thus resulting inner space is provided with sound absorbing material or sound absorbing materials, e.g. completely filled with the latter. In the following, these materials will be described in more detail.

According to the invention, at least one hydrocarbon storing element 28, 28′ is provided in the exhaust gas outlet 20 and/or in the combustion air supply 12. However, a plurality of hydrocarbon storing elements 28, 28′ can also be arranged e.g. in different positions in the exhaust gas outlet 20 and/or in the combustion air supply 12. In the depicted embodiment, one hydrocarbon storing element 28′ and 28, respectively, is provided in each of the exhaust gas outlet sound absorber 26 and the combustion air supply sound absorber 24. Arrangement of the hydrocarbon storing elements 28, 28′ in the respective sound absorbers 24 and 26 has the advantage that no further components have to be provided. The hydrocarbon storing element 28, 28′ comprises a structure allowing storage of unburned hydrocarbons. In particular, the hydrocarbon storing element 28, 28′ comprises a very large surface in relation to its volume such that a large storage capacity is provided with small required volume. At least the surface of the hydrocarbon storing element 28, 28′ is provided with a structure on which unburned hydrocarbons adsorb. Particularly suited for this are in particular some noble metal and activated-coal coatings.

In the embodiment shown, the hydrocarbon storing elements 28, 28′ each simultaneously form a sound absorbing element of the combustion air supply sound absorber 24 and of the exhaust gas outlet sound absorber 26, respectively. For this purpose, the hydrocarbon storing element 28 and 28′, respectively, comprises an open-pored porous structure through which the combustion air and the combustion exhaust gases, respectively, can flow. In particular a foam-like or grid-like structure is possible.

For a hydrocarbon storing element 28 in a combustion air supply 12, e.g. in a combustion air supply sound absorber 24, in particular synthetic foams are possible which are coated with an activated-coal coating. For a hydrocarbon storing element 28′ in an exhaust gas outlet 20, in particular open-pored porous metal or ceramic structures which can be flown through and which are provided with a noble metal coating are possible, since substantially higher temperatures occur there as compared to a combustion air supply.

In FIGS. 2 a) to e) different possible arrangements of hydrocarbon storing elements 28, 28′ in a combustion air supply sound absorber 24 or in an exhaust gas outlet sound absorber 26 are shown. The schematic illustrations each show possible arrangements for a combustion air supply sound absorber 24 as well as for an exhaust gas outlet sound absorber 26, as indicated by provision of two reference signs (24/26 and 28, 28′) in each case.

FIG. 2 a) shows an example in which the hydrocarbon storing element 28, 28′ simultaneously forms the sound absorbing element of the sound absorber 24 or 26, respectively. The hydrocarbon storing element 28, 28′ is arranged in the sound absorber such that it is passed through by the combustion air or by the combustion exhaust gases, respectively. Such a realization is advantageous if the material of the hydrocarbon storing element 28, 28′ at the same time comprises highly sound absorbing properties. In the embodiment shown, the hydrocarbon storing element 28, 28′ fills the entire interior of the sound absorber 24 or 26, respectively. However, a realization is also possible in which the interior is only partly filled by the element. In the example, a sound absorber having a substantially cylindric shape (to which the invention is not restricted) is depicted. Beginnings of pipes are schematically depicted laterally on the sound absorber 24 or 26, the pipes illustrating portions of the exhaust gas outlet 20 or the combustion air supply 12. In operation of the burner 4, the combustion air or the combustion exhaust gases flow into the sound absorber 24/26 and out of the latter along the depicted arrows.

FIG. 2 b) shows another example in which only a part of the sound absorbing material 30 in the sound absorber 24 or 26 is replaced by a hydrocarbon storing material 28, 28′. Such a realization is e.g. advantageous if the hydrocarbon storing material 28, 28′ does not comprise sound absorbing properties to the same extent as a sound absorbing material 30 (e.g. a synthetic foam, metal or ceramic foam, etc.) which is typical for sound absorbers.

FIGS. 2 c) to f) exemplarily show further possible arrangements of hydrocarbon storing material 28, 28′ and sound absorbing material 30 in a sound absorber 24 or 26. However, the invention is not restricted to these exemplary arrangements and different further arrangements are possible.

Depending on the material used, the storing properties of the hydrocarbon storing elements can be selected such that storing of the unburned hydrocarbons accumulating over the lifetime of the mobile heating device is enabled. However, arrangements are also possible in which the stored hydrocarbons have to be removed in regular intervals, e.g. in the course of normal maintenance. Depending on the selected storing material, this can be accomplished e.g. by replacing the hydrocarbon storing element or e.g. by baking out or the like.

The present invention is not restricted to the embodiments depicted in the figures. In FIG. 1, a burner having an atomizing nozzle is depicted. However, the invention is realizable independent from the respective type of burner. In particular, the invention is not restricted to the described vehicle parking heater but also realization in other mobile heating devices is possible, in particular in those discussed in the introductory portion.

Although it has been described with regard to the embodiment that both the exhaust gas outlet sound absorber and the combustion air supply sound absorber are each provided with a hydrocarbon storing element, the present invention is not restricted to this and it is e.g. also possible to provide only one sound absorber with a hydrocarbon storing element. Further, the invention is not restricted to an arrangement of the hydrocarbon storing element (or of hydrocarbon storing elements) in a sound absorber (although this preferred for space-saving reasons below others). A hydrocarbon storing element can e.g. also be arranged at a different position in the combustion air supply and/or in the exhaust gas outlet. The mobile heating device does not necessarily have to comprise an exhaust gas outlet sound absorber and a combustion air supply sound absorber but may also comprise one of these or even none of these.

1. A mobile heating device, in particular vehicle heating device, comprising:
a burner in which fuel and combustion air are convertible producing heat;
a combustion air supply for supplying the combustion air to the burner;
an exhaust gas outlet for discharging combustion exhaust gases from the burner; and
wherein a hydrocarbon storing element is arranged in the combustion air supply and/or in the exhaust gas outlet.

2. The mobile heating device of claim 1, wherein the hydrocarbon storing element comprises a structure capable of being flown through having a large surface in relation to its volume.

3. The mobile heating device of claim 1, wherein the hydrocarbon storing element is adapted for storing hydrocarbons by adsorption.

4. The mobile heating device of claim 1, wherein the hydrocarbon storing element is arranged such that it is passed through by the combustion air or the exhaust gases during operation of the heating device.

5. The mobile heating device of claim 1, wherein in both the combustion air supply and the exhaust gas outlet a hydrocarbon storing element is arranged.

6. The mobile heating device of claim 1, wherein the hydrocarbon storing element is the sound absorbing element in a sound absorber.

7. The mobile heating device of claim 1, wherein the hydrocarbon storing element is arranged in a combustion air supply sound absorber absorbing noise arising from combustion air being supplied to the heating device.

8. The mobile heating device of claim 1, wherein the hydrocarbon storing element is arranged in an exhaust gas outlet sound absorber absorbing noise arising from combustion exhaust gases being discharged.

9. The mobile heating device of claim 1, wherein the hydrocarbon storing element comprises a fully or partly porous structure, in particular a foam structure, a honeycomb structure, or a fiber structure.

10. The mobile heating device of claim 1, wherein the hydrocarbon storing element is formed by a carrier structure having a hydrocarbon adsorbing coating.

11. The mobile heating device according to claim 10, wherein the hydrocarbon adsorbing coating is a noble metal coating.

12. The mobile heating device of claim 10, wherein the hydrocarbon adsorbing coating is an activated-carbon coating.

13. A combustion air supply sound absorber for a mobile heating device which comprises:
a burner in which fuel and combustion air are convertible producing heat;
a combustion air supply for supplying the combustion air to the burner;
an exhaust gas outlet for discharging combustion exhaust gases from the burner; and
wherein a hydrocarbon storing element is arranged in a flow path of the combustion air supply sound absorber.

14. An exhaust gas outlet sound absorber for a mobile heating device which comprises:
a burner in which fuel and combustion air are convertible producing heat;
a combustion air supply for supplying combustion air to the burner;
an exhaust gas outlet for discharging combustion exhaust gases from the burner; and
wherein a hydrocarbon storing element is arranged in a flow path of the exhaust gas outlet sound absorber.
